(19) United States
(12) Patent Application Publication
(10) Pub. No.: US 2014/0379596 A1
(43) Pub. Date: Dec. 25, 2014

(54) CLOUD-BASED AUDITING AND MANAGEMENT OF LICENSES TO USE COMPUTER PRODUCTS

(71) Applicant: CISCO TECHNOLOGY, INC., San Jose, CA (US)

(72) Inventors: Richard PRUSS, San Jose, CA (US); Morry KATZ, San Jose, CA (US); Somyajit JENA, San Jose, CA (US); Alex WIGHT, San Jose, CA (US); Steve KOEHLER, San Jose, CA (US); Ben STRICKLAND, San Jose, CA (US)

(21) Appl. No.: 13/924,604

(22) Filed: Jun. 23, 2013

(51) Int. Cl. G06Q 30/00

(52) U.S. Cl. CPC G06Q 30/0185
USPC 705/318

(57) ABSTRACT

Techniques are provided for auditing and managing licenses for use of computer products. A license manager of a vendor receives an identifier of a computer product and a report of a set of licensed features enabled on the computer product. The license manager identifies a customer account associated with the identifier. The customer account includes a pool of entitlements acquired by the customer. The license manager compares the report with the entitlements in the pool, and with the customer's use of other computer products which draw entitlements from that pool, to generate a comparison result. An authorization decision of “in compliance” or “out of compliance” may be returned to the requesting computer product.

### TECHNICAL FIELD

Embodiments presented in this disclosure generally relate to software licensing and, more particularly, to techniques for providing cloud-based auditing and management of licenses, or other entitlements, to use computer software and hardware.

### BACKGROUND

Licenses for computer software and hardware are typically provided to end-user customers via a product activation key (PAK). A PAK is a code that a customer uses to enable, activate, or access features on computer products. The customer associates a PAK with a specific software product (or hardware device) by entering the PAK into a portal, which returns a cryptographic license key. When associated with a specific device, the license key unlocks features on the specific device or allows a software installation process to be completed. Accordingly, through a three-step process (from PAK, to license key, and to device configuration), the customer proves product ownership directly for every single software application installed on a hardware device as well as for each hardware device itself. For example, a user may activate a network router by entering a license key into an interface on the network router. In response, the router passes information to the vendor, which validates the PAK and provides any license or use keys. In turn, the license key (or other information) is node-locked on the network router. Similarly, software may be activated by entering a PAK in an interface presented by an install tool. This licensing approach delegates decisions to enforce the software license into the hardware device (e.g., switch, router, etc.) or software application.

Such an approach is problematic where a vendor uses a channel partner (e.g., reseller) to distribute products to an end customer. The channel partner receives each PAK from the vendor and passes the PAK to a customer. When the PAK is sent to the vendor, the vendor typically does not know the identity of the customer. While the customer may include an identity when registering a hardware/software product, the customer may do so independently for each software product or hardware device.

The disconnect that results from independently registering/activating each hardware device or software installation results in a lack of an inventory of what licenses are owned (or used), for both the vendor and the customer. That is, the vendor and the end customer are often unaware of exactly what licenses a given customer has acquired. Further, this approach limits the ability of a customer to change how license rights are used, as license keys are typically node locked to a single device installation or hardware device. For example, assume a customer (e.g., a university) purchases from a reseller (e.g., a network equipment reseller) licenses for software. Assume, for example, that the software configures a local area network (LAN) to provide firewall services and that the customer acquires licenses for twelve routers. The customer receives license PAKs for the software for use on the twelve routers. Sometime later, the customer decides to purchase database services from the reseller, while downgrading the firewall services and implementing the software on only ten routers, instead of twelve routers. The licensing scheme does not provide a mechanism for the customer for such a change in license use or allocation across their devices.

Further, to address compliance issues, the vendor may administer an auditing process after the fact to determine whether the customer is in compliance with their acquired license rights. However, doing so is complex, is expensive, and can cause poor customer relations.

### BRIEF DESCRIPTION OF THE FIGURES

So that the manner in which the above-recited features of the present disclosure can be understood in detail, a more particular description of the disclosure, briefly summarized above, may be had by reference to embodiments, some of which are illustrated in the appended figures. It is to be noted, however, that the appended figures illustrate only typical embodiments of this disclosure and are therefore not to be considered limiting of its scope, for the disclosure may admit to other equally effective embodiments.

FIG. 1 illustrates an example license manager configured to perform auditing and management operations, according to one embodiment.

FIG. 2 illustrates an example auditing infrastructure, according to one embodiment.

FIG. 3 illustrates an example customer purchase, according to one embodiment.

FIG. 4 illustrates example vendor computing system, which is configured to audit and manage licenses for using computer products, according to one embodiment.

FIG. 5 illustrates example license data, according to one embodiment.

FIG. 6 illustrates an example method for the license manager device to register a computer product, according to one embodiment.

FIG. 7 illustrates an example auditing and managing method for the license manager device to audit and manage license rights for the license enforcer device, according to one embodiment.

### DESCRIPTION

### Overview

Embodiments provide a method, computer program product and system that provide cloud-based auditing and management of licenses to use computer products. Such a method may generally include receiving, by a license manager device in a vendor cloud, a first identifier of a first computer product and a first identification of a set of licensed features enabled on the first computer product. This method may also include identifying a customer account associated with the first identifier. The customer account includes a set of entitlements for computer products associated with the customer account. This method may further include comparing the first report with the set of entitlements to generate a first comparison result, generating a first authorization decision based on at least the first comparison result, and communicating the first authorization decision to the first computer product based on the comparison report.

### DESCRIPTION OF EXAMPLE EMBODIMENTS

Embodiments presented herein provide cloud-based auditing and management of entitlements to use computer software and hardware. A customer purchases one or more computer products from a vendor. A license manager generates a customer account. The customer account includes one or more pools of licenses. A pool of licenses includes a set of entitlements acquired by the customer that grant the rights to use the computer products (e.g., hardware, software, or features of same). The computer product may include components used to register the computer product with the license manager. To do so, the license enforcer sends a message identifying a given computer product and identifying what features are configured for use. Based on the information received from the computer products, the license manager audits the licensed features of the computer products. That is, the license manager evaluates what features are subject to a license or an entitlement right from the vendor across all the computer products registered with the license manager to determine a compliance state for that customer account. For example, the auditing may include comparing the use of licensed features to the pools of entitlements associated with the customer account. The license manager device aggregates the comparison results and generates authorization decisions. The license manager device then sends an authorization decision to each computer product. The authorization decision may indicate whether the customer, collectively, is in compliance with the entitlements acquired by that customer (as reflected by the entitlement pools associated with a given customer account). For example, the authorization may indicate whether the customer has sufficient entitlements for the number of seats installed or the number of devices or features enabled on the devices. The authorization decision may include instructions to limit the availability or functionality of the software or hardware, at least in the case of long-term non-compliance.

In one embodiment, the authorization decision may take the form of a digital certificate signed by a vendor root (or an authorization message signed with a digital signature validated against a vendor certificate). Such a certificate may include a validity period (e.g., ninety days) specifying that the device (and the customer generally) is in compliance, i.e., that there are sufficient entitlements in the customer account to use the device as indicated by the reported licensed features. The compliance state generally corresponds to the validity period of the certificate. After a certain period (e.g., thirty to forty-five days), the license enforcer may send another status report to the vendor, allowing a new authorization decision (and corresponding certificate or signed message) to be received prior to the expiration of the validity period. Note, while each computer product reports a configuration state to the vendor, the resulting authorization decision generally reflects the overall entitlement state of the customer account.

If the authorization decision indicates that the customer is not in compliance, (i.e., there are insufficient entitlements in the customer account) then the license enforcer can alter the operation of the computer product to encourage the customer to either change how their computer products are deployed or to acquire additional entitlements. Note, in some cases, this may simply be to present messages indicating that the current use is not in compliance. However, in other cases, the license enforcer may disable features of the product.

Advantageously, the license manager can send information stored in the database to a vendor management console and/or customer management console. The vendor and/or the customer can view the information on demand on the respective consoles. The license manager device can thereby provide an accurate profile of registered computer products, entitlements, licensed features, and authorization decisions associated with the customer account.

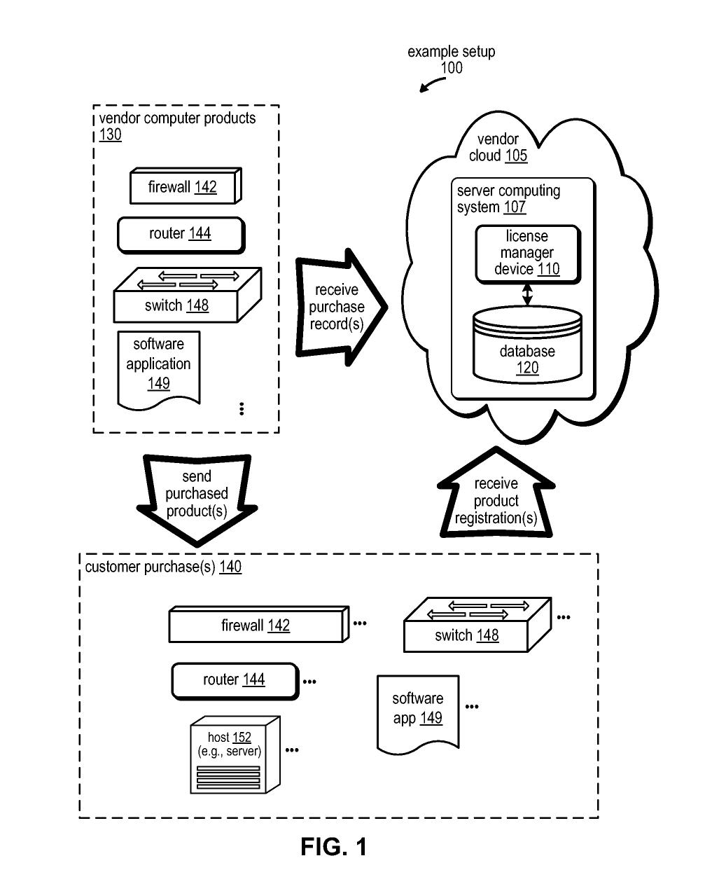

FIG. 1 is a conceptual diagram of an example setup 100, which prepares a license manager 110 to perform auditing and management operations, according to one embodiment. Before the license manager device 110 performs auditing and management operations, the license manager device 110 can perform setup operations, including, for example, generating a customer account associated with purchased computer products and registering the purchased computer products in the customer account.

As shown in FIG. 1, a vendor has computer products 130 available for purchase. For example, the vendor may be selling networking products, including a firewall 142, a router 144, a switch 148, and a software application 149. In this example, the customer purchases 140 include a firewall 142, a router 144, a switch 148, a software application 149, and a host 152 (e.g., server).

A server computing system 107 receives purchase records that describe the transactions involving the purchased computer products. For example, the purchase records may indicate what entitlements a given customer has acquired (and should be added to an entitlement pool associated with that customer in the vendor cloud 105). As shown, the server computing system 107 resides on a vendor cloud 105 and includes a license manager device 110 connected to a database 120. In some embodiments, the vendor cloud 105 can deliver license management services (via servers, storage, and applications) to both vendor computers and customer computers.

Upon receiving the purchase records, the license manager device 110 stores a customer account with the purchased products (and entitlements) in the database 120. The customer account may include an initial pool of entitlements. A pool of entitlements includes a set of licenses or other rights acquired by a customer to use a given computer product or family of products. A customer may create different pools of entitlements to manage different types of computer products as well as to manage the allocation of entitlements across an enterprise. Further, the customer may move entitlements from one pool to another. For example, assume that a customer creates an individual entitlement pool for different departments within an organization. If devices drawing entitlement from a first pool fall out of compliance, the customer could move entitlements from another pool to bring the first pool back into a compliant state. More generally, the customer may control what entitlements are associated with that pool.

To activate a computer product, the customer registers the computer product with the license manager device 110. The registration may include an identifier of the computer product, the customer, and any entitlements associated with that product. Once registered, the license manager device 110 may audit the use of computer products purchased by the customer.

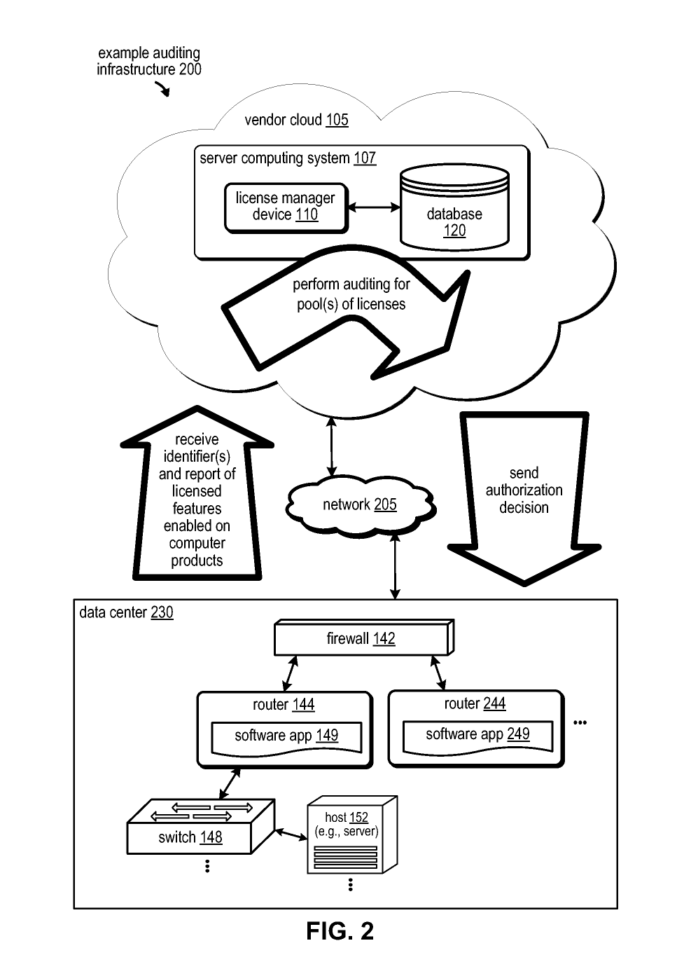

FIG. 2 is a conceptual diagram of an example auditing infrastructure 200, according to one embodiment. A network 205 (e.g., the Internet) connects the vendor cloud 105 and a data center 230. In some embodiments, the connectivity via the network 205 is infrequent or nonexistent, for example, where the data center 230 is operating a secure network dissociated from outside networks. In such a case, the customer may infrequently establish an offline connection to the vendor cloud 105 by using, for example, a portal and/or email, among other ways of communicating with the vendor cloud 105 without the data center 230 being connected to the network 205.

As shown in FIG. 2, the data center 230 includes computer products purchased by the customer that are connected to the customer's network infrastructure. In this example, the data center 230 includes a firewall 142 connected to the router 144 and a router 244. The router 144 is connected to the switch 148, which is connected to the host 152 (e.g., server). In this example, the software application 149 resides on the router 144 and the software application 249 resides on the router 244.

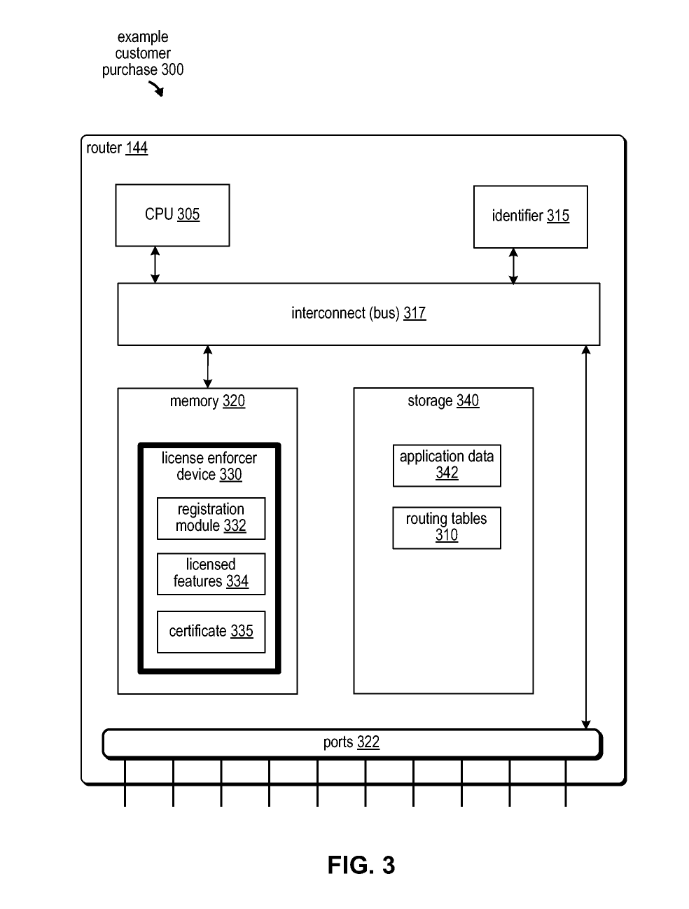

In some embodiments, the license manager device 110 receives information from each purchased computer product deployed within the data center 230. That is, the license manager device 110 can receive a product identifier and information specifying the licensed features (e.g., configuration state) enabled on each computer product. As an example, the customer may configure router 144, 244, to have five ports open and run a specific version of router software. In one embodiment, a cryptographic identifier identifies each router (or other computer product). Periodically, a license enforcer (e.g., license enforcer 330 of FIG. 3) reports the licensed features of the respective computer product to the license manager 110.

In some embodiments, the identification of the licensed features is received in a form of a request to use features that may be subject to an entitlement. In some embodiments, a response to the request is not needed in real time. That is, a computer product may continue to use the configured features before the license enforcer receives an authorization decision from the license manager device 110.

Once the license manager device 110 receives the product identifier and the identification of the licensed features, the license manager device 110 identifies a customer account linked to the product identifier in the database 120. The license manager device 110 compares the licensed features used by that computer product with a pool of entitlements associated with the customer account. For example, the pool of license entitlements may authorize the customer to use ten routers with five open ports per router. The report of the licensed features may include four open ports for the particular router. Meanwhile, the license manager device 110 may receive, for example, reports from other routers in the customer data center 230. The license manager device 110 stores the reports and the comparison results in the database 120.

Note, while the example referenced above uses a single entitlements pool, a customer account may include multiple license pools. For example, the customer could add entitlements to operate ten routers with four ports open per router to one pool. The customer could also add entitlements to operate five routers with three ports open per router to a second pool. In some embodiments, the license manager device 110 can move entitlements from one license pool to another. For example, the license manager device 110 may move entitlements for three routers from the second license pool to the first license pool.

The license manager device 110 aggregates the comparison results generated for each of the computer products drawing entitlements from a common entitlements pool. Based on the aggregation, the license manager device 110 can generate an authorization decision for each computer product (e.g., each of the ten routers). For example, if the ten routers are each configured with four open ports and the entitlements authorize ten routers with five open ports each, then the license manager device 110 can generate an authorization result of “in-compliance” for each of the ten routers. In contrast, if the ten routers are each configured with six open ports and the entitlements authorize ten routers with five open ports each, then the license manager device 110 can generate an authorization decision of “out-of-compliance” for each of the ten routers.

The license manager device 110 can send the authorization decision to each respective computer product that reported a configuration state or use of licensed features to the license manager device 110 in the vendor cloud. As discussed below, in one embodiment, the authorization decision may be stored in (or signed by) a digital certificate indicating a validity period for the authorization decision.

In sum, the auditing operations of the license manager 110 can include identifying a customer account based on a product identifier, comparing configuration reports with a pool of licenses, storing comparison results, aggregating the comparison results, generating authorization decisions based on the aggregation of the comparison results, sending authorization decisions to each license enforcer, and updating the pool of licenses as necessary.

The license enforcer (e.g., license enforcer 330 of FIG. 3) on each computer product receives an authorization decision. As noted, the authorization decision may generally indicate whether the customer account is “in compliance,” i.e., the decision may indicate whether the pool from which the requesting computer product draws entitlements has enough entitlements for all the devices relying on entitlements from that pool, or is “out of compliance,” i.e., the pool from which the requesting computer product draws entitlements does not have enough entitlements for all the devices relying on entitlements from that pool.

In some embodiments, the authorization decision includes instructions to be carried out by the license enforcer. For example, an authorization decision may include instructions to disable use of a computer product due to the license manager device determining a particular computer product is out of compliance.

Advantageously, the license manager device 110 can send information stored in the database 120 to a vendor management console and/or customer management console. The vendor and/or the customer can view the information on demand and thereby obtain an accurate profile of registered computer products, entitlements, licensed features, and/or authorization decisions associated with the customer account.

FIG. 3 is a diagram of an example customer purchase 300, according to one embodiment. For explanatory purposes, the customer purchase 300 includes a router 144. In context of this description, the computing elements shown in the router 144 correspond to hardware components and software modules (e.g., hardware and software in the data center 230 of FIG. 2).

As shown, the router 144 includes, without limitation, a central processing unit (CPU) 305, an identifier 315, a memory 320, storage 340, and ports 322, each connected to a bus 317. The CPU 305 retrieves and executes programming instructions stored in the memory 320, as well as stores and retrieves application data 342 and routing tables 310 residing in the storage 340. Via the bus 317, the router 144 transmits programming instructions and application data 342 between the CPU 305, the identifier 315, the storage 340, the memory 320, and the ports 322. Note that the CPU 305 is included to be representative of a single CPU, multiple CPUs, a single CPU having multiple processing cores, and/or the like. The memory 320 is included to be generally representative of a random access memory. The storage 340 may be a disk drive storage device.

In this example, a license enforcer 330 resides on the memory 320. The license enforcer 330 includes a registration module 332, a set of licensed features 334 enabled on the router 144, and a certificate received from the license manager device of the vendor. The license enforcer 330 includes the registration module 332 and the router licensed features 334. The registration module 332 is configured to register the router 144. The registration module 332 is configured to send the identifier 315, or a copy of the identifier 315, and the licensed features 334 to a license manager device of a vendor. The certificate 335, received from the license manager device, authorizes the router 144 to operate according to entitlements stored in a vendor cloud 105 by the license manager device. That is, the certificate 335 indicates that the router 144 is being operated “in compliance,” and the pool from which the router 144 draws entitlements has enough entitlements for all the devices relying on that pool for entitlements. In some embodiments, the certificate 335 has a validity period (e.g., ninety days). Once the validity period expires, the license enforcer 330 may notify the customer that the certificate used to validate an “in compliance” state has expired. The certificate 335 may also have a renewal period (e.g., thirty days) that is less than the validity period (e.g., ninety days). Once the renewal period expires, the license enforcer attempts to renew the certificate 335. That is, the trigger for the router 144 to communicate with the vendor to obtain a license authorization may be substantially less than the validity period for an “in compliance” state. Doing so may provide a customer with sufficient time to obtain a new authorization decision (i.e., a new certificate with a new validity period) as well as to identify and remedy the cause of a non-compliant situation.

The identifier 315 is shown as a hardware component (e.g., a hardware chip containing cryptographic data) connected to the bus 317. Alternatively, the identifier 315 may include cryptographic data stored in the storage 340 or memory 320. In some implementations, the identifier 315 also has a validity period, which is typically longer than the validity period for the certificate 335 (e.g., one year). Once the validity of the certificate 335 has expired, the license enforcer 330 may be configured to perform a set of instructions (e.g., send out a warning to a customer portal). Where the validity of the identifier 315 has expired, the license enforcer 330 may be configured to perform another set of instructions (e.g., disable some (or all) functionality of the router 144).

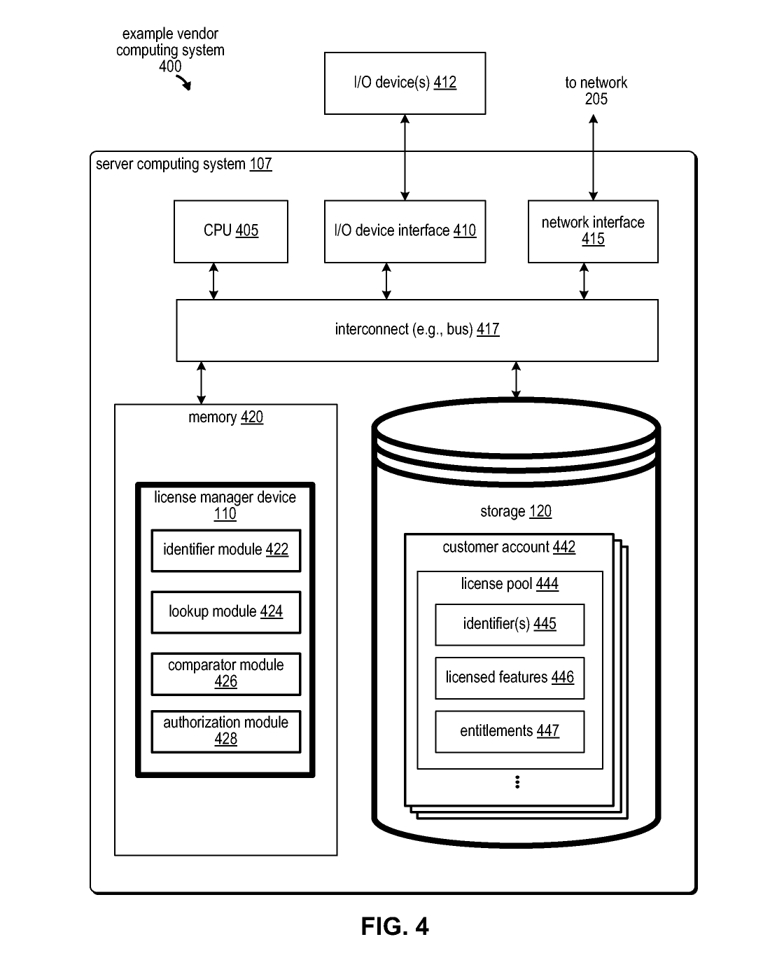

FIG. 4 is a diagram of an example vendor computing system 400 configured to audit and manage licenses for using computer products, according to one embodiment.

As shown, the vendor computing system 400 includes a central processing unit (CPU) 405, an I/O device interface 410, a network interface 415, a memory 420, and storage 120, each connected to a bus 417. The I/O device interface 410 connects I/O devices 412 (e.g., keyboard, display, and mouse devices) to the vendor computing system 400. Further, in context of this description, the computing elements shown in vendor computing system 400 may correspond to a physical computing system (e.g., a system in a data center) or may be a virtual computing instance executing within the vendor cloud 105 of FIGS. 1 and 2.

The CPU 405 retrieves and executes programming instructions stored in the memory 420, as well as stores and retrieves application data residing in the storage 120. Via the bus 517, the server computing system 107 transmits programming instructions and application data between the CPU 405, the I/O devices interface 410, the storage 120, the network interface 415, and the memory 420. Note that CPU 405 is included to be representative of a single CPU, multiple CPUs, a single CPU having multiple processing cores, and/or the like. The memory 420 is included to be generally representative of a random access memory. The storage 430 may be a disk drive storage device. Although shown as a single unit, the storage 430 may be a combination of fixed and/or removable storage devices, such as fixed disc drives, removable memory cards, or optical storage, network attached storage (NAS), or a storage area-network (SAN).

A license manager device 110 resides on the memory 420 and includes, without limitation, an identifier module 422, a lookup module 424, a comparator module 426, and an authorization module 428. The identifier module is configured to receive a product identifier and a set of licensed features from a license enforcer of a computer product. Based on the product identifier, the lookup module 424 is configured to lookup a customer account 442 based on the product identifier. The comparator module 426 is configured to compare information in the customer account 442 with the licensed features received from the computer product. The comparator module 426 stores the licensed features and the comparison result in the customer account 442. The comparator module 426 also stores licensed features received from other computer products in the data center 230 and stores the corresponding comparison results. The authorization module 428 aggregates the comparison results and generates authorization decisions for the computer products associated with the license pool 444 of the customer account 442.

Accordingly, the storage 120 includes, without limitation, one or more customer accounts, such as customer account 442. Each customer account includes one or more license pools, such as license pool 444, which includes one or more identifiers 445 of computer products, the licensed features 446 of the computer products, and the entitlements for using the computer products 447.

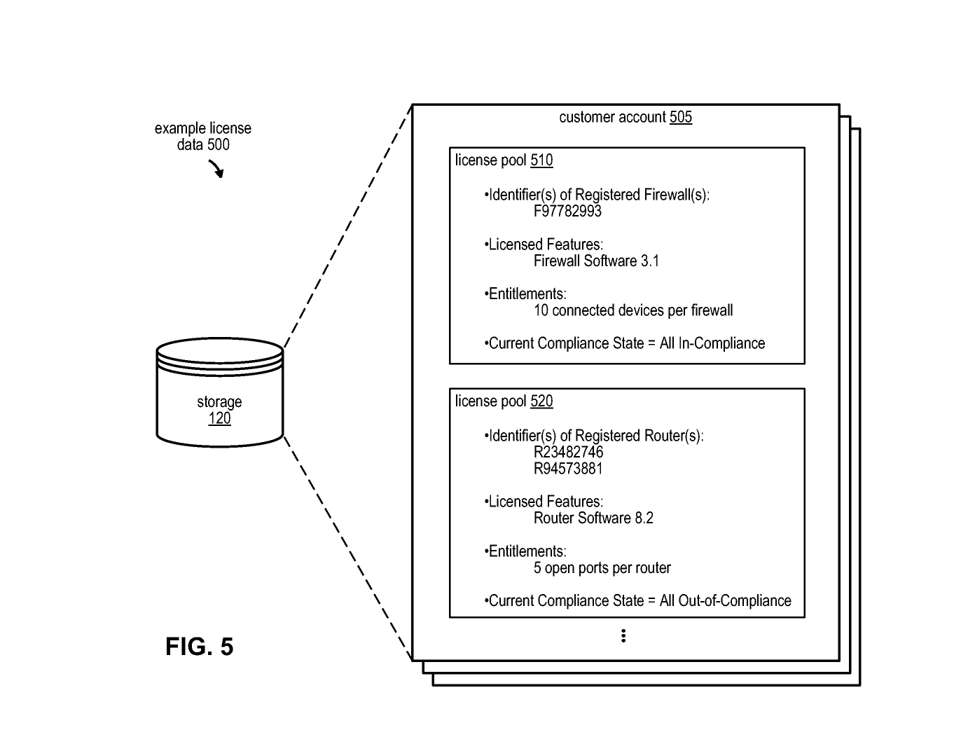

FIG. 5 is a conceptual diagram of example license data 500 in the storage 120, according to one embodiment. In this example, the license data 500 includes information regarding multiple customer accounts, including a customer account 505. The customer account 505 includes multiple license pools, including a license pool 510 and a license pool 520.

The license pool 510 includes an identifier of a registered firewall. The set of licensed features of the registered firewall indicates the registered firewall is configured to run Firewall Software 3.1. The entitlements indicate the registered firewall is authorized to have ten connected devices. The current compliance state indicates the registered firewall is in-compliance.

The license pool 520 includes identifiers of registered routers. The current set of licensed features of the registered routers indicates the routers are configured with Router Software 8.2. The entitlements indicate the registered routers are authorized to have five open ports per router. The current compliance state indicates the registered routers are out-of-compliance.

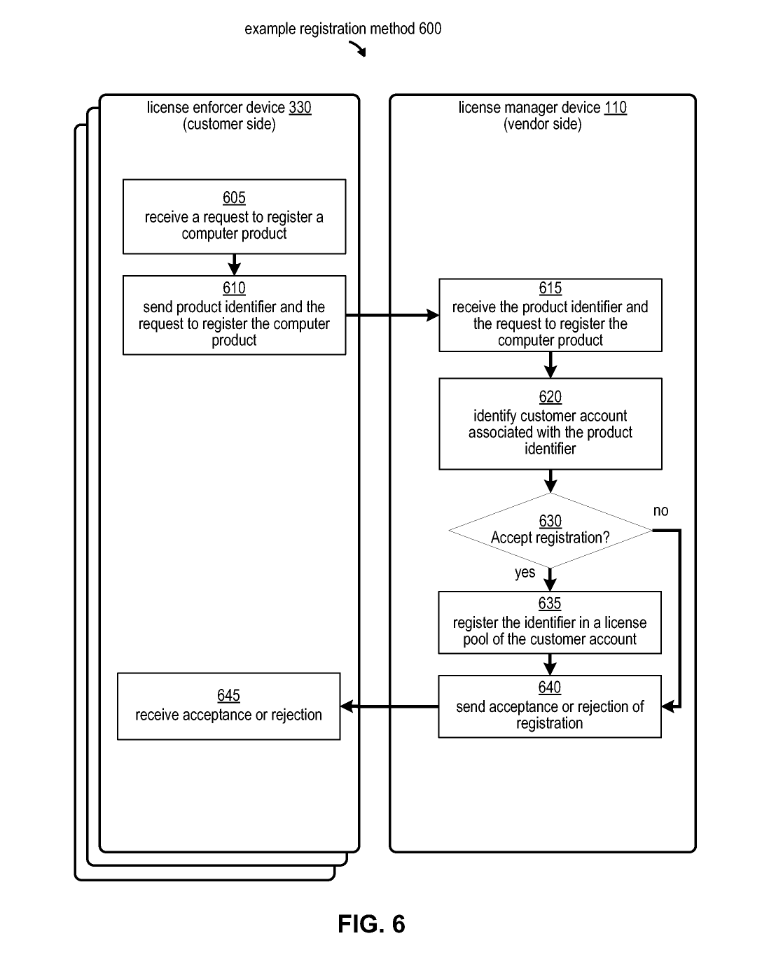

FIG. 6 illustrates a method 600 for the license manager device 110 to register a computer product, according to one embodiment. The registration method 600 is part of setup operations discussed above with reference to FIG. 1

At step 605, the license enforcer 330 on a computer product receives a request to register that computer product. For example, when a customer first connects a router to their network infrastructure, the software on that device may present a registration interface used to configure features on the router, as well as register the device with the license manager on the vender could. At step 610, the license enforcer 330 sends the product identifier and the request to register the computer product to the license manager device. At step 615, the license manager device 110 on the vendor side receives the request.

At step 620, the license manager device 110 identifies a customer account associated with the product identifier. In some embodiments, the customer account is created at the time of purchase. At step 630, the license manager device 110 determines whether to accept the registration. If the license manager device 110 accepts the registration, then at step 635, the license manager device 110 associates the identifier with a license pool which the device will rely upon to authorize the use of licensed features on that device. At step 640, the license manager device 110 sends a message notifying the license enforcer that the registration is complete. However, if the license manager device 110 rejects the registration, at step 640, the license manager device 110 sends a rejection to the license enforcer 330. At step 645, the license enforcer 330 receives either the message accepting or rejecting the registration.

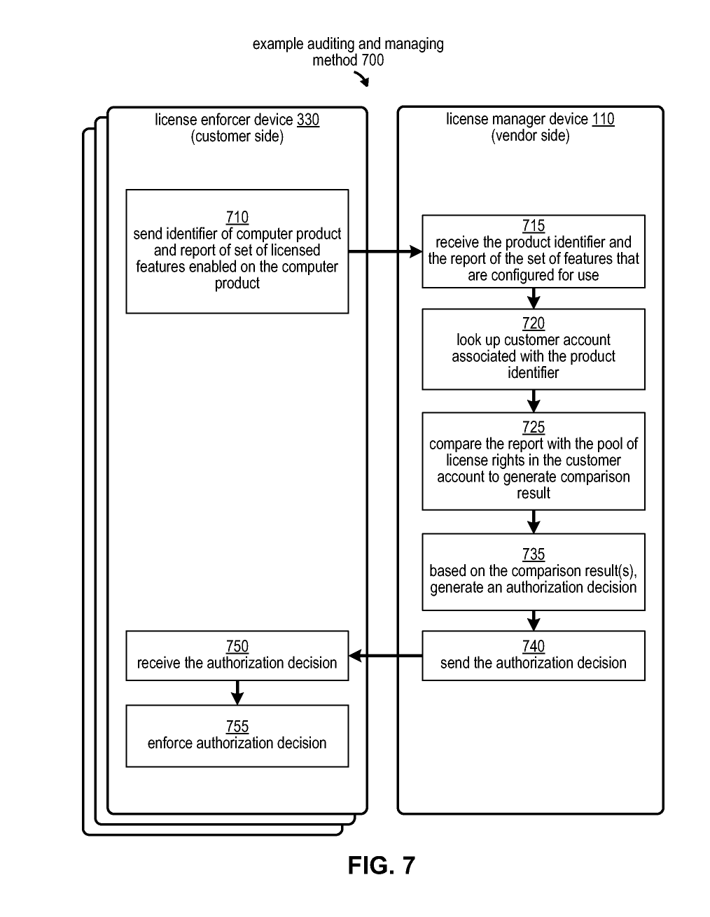

FIG. 7 illustrates a method 700 for auditing license rights, according to one embodiment. At step 710, the license enforcer 330 sends a product identifier and a report of a set of features configured for use on the computer product to the license manager device 110. For example, a router may be configured to have five open ports while running a specific version of router software. In such a case, this information is reported to the license manager along with the product identifier. At step 715, the license manager device 110 receives the product identifier and the report.

At step 720, the license manager device 110 identifies a customer account associated with the product identifier. In some cases, the license manager device 110 may not find a corresponding customer account due to, for example, if the license manager device rejected registration of the computer product. In such a case, the license manager device can return a message indicating “non-compliance” with license entitlements. At step 725, the license manager device 110 compares the report with the pool of license rights in the customer account to generate a comparison result. In a similar manner, the license manager device 110 can generate comparison results for other computer products drawing entitlements from that license pool.

At step 735 the license manager device 110 generates an authorization decision for the computer product, based on the one or more comparison results. For example, the license manager device 110 aggregates the comparison results to generate an aggregated comparison result. Based on the aggregated comparison result, the license manager device 110 can generate an authorization decision for each computer product drawing entitlements from the pool. In one embodiment, the authorization decisions are the same for each computer product associated with a given license pool. At step 740, the license manager device 110 sends the authorization decision to the license enforcer 330. In a similar manner, the license manager device 110 can send an authorization decision to other computer products relying on that pool for entitlements. At step 750, the license enforcer receives the authorization decision, which indicates the computer product is either in compliance or out of compliance.

In some embodiments, the authorization decision may include instructions performed by the license enforcer. In some embodiments, the authorization decision includes a certificate that has a validity period (e.g., 90 days). Alternatively, the authorization decision is signed with a digital signature validated against a certificate issued to the vendor. If the computer product has not renewed the certificate prior to the end of the validity period, then license enforcer 330 may be configured notify the customer that the validity period has expired, or in some cases take stronger enforcement actions. Further, the license enforcer may operate using a much shorter renewal period (relative to the validity period) and attempt to renew the certificate or obtain a new authorization decision. For example, assume the certificate has a validity period of 90 days. In such a case, a renewal period may be as short as 30 days. Doing so gives the device (and ultimately the customer) time to renew the authorization decision, or correct an out of compliance state, without creating any disruption to that customer. At step 755, the license enforcer enforces the instructions of the authorization decision. For example, the license enforcer may disable use of the computer product if the authorization decision indicates the computer product is out of compliance or, more generally notify the customer that the entitlements in the pool managed by the vendor are insufficient for the computer products relying on the entitlements in that pool.

These methods may include other steps and/or details that are not discussed in this methods overview. Other steps and/or details described herein may be a part of the methods, depending on the implementation. A person skilled in the art will understand that any system configured to implement the method steps, in any order, falls within the scope of the present invention.

While the forgoing is directed to embodiments of the present disclosure, other and further embodiments of the disclosure may be devised without departing from the basic scope thereof. For example, aspects of the present disclosure may be implemented in hardware, software, or a combination of hardware and software. One embodiment of the disclosure may be implemented as a program product for use with a computer system. The program(s) of the program product define functions of the embodiments (including the methods described herein) and can be contained on a variety of computer-readable storage media. Illustrative non-transitory computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., a hard-disk drive or solid-state random-access semiconductor memory) on which alterable information is stored. Such computer-readable storage media, when carrying computer-readable instructions that direct the functions of the present disclosure, are embodiments of the present disclosure.

In view of the foregoing, the scope of the present disclosure is determined by the claims that follow.

We claim:

1. A method, comprising:
receiving, by a license manager device in a vendor cloud, a first identifier of a first computer product and a first identification of a set of licensed features enabled on the first computer product;
identifying a customer account associated with the first identifier, wherein the customer account includes a set of entitlements for computer products associated with the customer account;
comparing the first report with the set of entitlements to generate a first comparison result;
generating a first authorization decision based on at least the first comparison result; and
communicating the first authorization decision to the first computer product based on the comparison report.

2. The method of claim 1, wherein the first authorization decision includes a certificate indicating that there are sufficient entitlements in the set of entitlements for the computer product to use the set of licensed features enabled on the first computer product.

3. The method of claim 2, wherein the certificate includes a validity period.

4. The method of claim 1, wherein the customer account includes a second set of entitlements.

5. The method of claim 1, further comprising:
receiving a second identifier of a second computer product and a second identification of a set of licensed features enabled on the second computer product;
comparing the second report with the set of entitlements to generate a second comparison result;
generating a second authorization decision based on at least the second comparison result; and
communicating a second authorization decision to the second computer product based on the second comparison report.

6. The method of claim 5, wherein the comparing comprises:
determining that the first computer product and the second computer product are authorized to use the set of entitlements by aggregating the first comparison result and the second comparison result to generate an aggregated comparison result; and
based on the aggregated comparison result, generating an authorization decision for the first computer product and the second computer product.

7. The method of claim 1, wherein the comparing comprises:
determining there are insufficient entitlements in the set of entitlements for the first computer product to use the set of licensed features enabled on the first computer product; and
determining the first computer product is out of compliance with the set of entitlements based on determining there are insufficient entitlements.

8. The method of claim 7, wherein the first authorization decision configures the first computer product to initiate enforcement operations that are associated with the first computer product being out of compliance.

9. The method of claim 8, wherein the enforcement operations on the first computer product include disabling one or more features of the first computer product based on the first computer product being out of compliance.

10. A computer program product, comprising:
computer code that receives a first identifier of a first computer product and a first identification of a set of licensed features enabled on the first computer product;
computer code that identifies a customer account associated with the first identifier, wherein the customer account includes a set of entitlements for computer products associated with the customer account;
computer code that compares the first report with the set of entitlements to generate a first comparison result;
computer code that generates a first authorization decision based on at least the first comparison result;
computer code that communicates the first authorization decision to the first computer product based on the comparison report; and
a computer-readable medium that stores the computer codes.

11. The computer product of claim 10, wherein the first authorization decision includes a certificate indicating that there are sufficient entitlements in the set of entitlements for the computer product to use the set of licensed features enabled on the first computer product.

12. The computer product of claim 11, wherein the certificate includes a validity period.

13. The computer product of claim 10, wherein the customer account includes a second set of entitlements.

14. The computer product of claim 10, further comprising:
a computer code that receives a second identifier of a second computer product and a second identification of a set of licensed features enabled on the second computer product;
a computer code that compares the second report with the set of entitlements to generate a second comparison result;
a computer code that generates a second authorization decision based on at least the second comparison result; and
a computer code that communicates a second authorization decision to the second computer product based on the second comparison report.

15. The computer product of claim 14, wherein the computer code that compares comprises:
a computer code that determines that the first computer product and the second computer product are authorized to use the set of entitlements by aggregating the first comparison result and the second comparison result to generate an aggregated comparison result; and
a computer code that generates an authorization decision for the first computer product and the second computer product based on the aggregated comparison result.

16. The computer product of claim 10, wherein the computer code that compares further comprises:
a computer code that determines there are insufficient entitlements in the set of entitlements for the first computer product to use the set of licensed features enabled on the first computer product; and
a computer code that determines the first computer product is out of compliance with the set of entitlements based on determining there are insufficient entitlements.

17. A system, comprising:
a processor; and
a memory hosting an application, which, when executed on the processor, performs an operation for managing entitlements to use computer products, the operation comprising:
receiving a first identifier of a first computer product and a first identification of a set of licensed features enabled on the first computer product;
identifying a customer account associated with the first identifier, wherein the customer account includes a set of entitlements for computer products associated with the customer account;
comparing the first report with the set of entitlements to generate a first comparison result;
generating a first authorization decision based on at least the first comparison result; and
communicating the first authorization decision to the first computer product based on the comparison report.

18. The system of claim 17, wherein the first authorization decision includes a certificate indicating that there are sufficient entitlements in the set of entitlements for the computer product to use the set of licensed features enabled on the first computer product.

19. The system of claim 18, wherein the certificate includes a validity period.

20. The system of claim 17, wherein the customer account includes a second set of entitlements.
